(19) United States
(12) Patent Application Publication
(10) Pub. No.: US 2014/0319252 A1
(43) Pub. Date: Oct. 30, 2014

(54) Food Waste Disposer With Stamped Swivel Lugs

(71) Applicant: Emerson Electric Co., St. Louis, MO (US)

(72) Inventor: Kevin MCCLORY, Racine, WI (US)

(73) Assignee: EMERSON ELECTRIC CO., St. Louis, MO (US)

(21) Appl. No.: 14/256,115

(22) Filed: Apr. 18, 2014

Related U.S. Application Data
(60) Provisional application No. 61/816,179, filed on Apr. 26, 2013.

(51) Int. Cl. E03C 1/266; B02C 18/18

(52) U.S. Cl. CPC E03C 1/2665; B02C 18/18
USPC 241/46.013

(57) ABSTRACT

A food waste disposer includes a food conveying section, a motor section and a grind and discharge section. The grind section includes a grind mechanism having a stationary grind ring and a rotatable shredder plate assembly that rotates within the stationary grind ring to grind food waste. The rotatable shredder plate assembly is rotated by a motor of the motor section. The rotatable shredder plate assembly includes a rotatable shredder plate having a plurality of stamped metal swivel lugs fastened thereon. Each lug includes a base and a face member at a radially outer end extending vertically upward from the base. The face member includes a grind face that bends radially inwardly with a rounded leading vertical outer edge. The base of each lug has a leading edge with a sharp lower edge.

### CROSS-REFERENCE TO RELATED APPLICATIONS

This application claims the benefit of U.S. Provisional Application No. 61/816,179 filed on Apr. 26, 2013. The entire disclosure of the above application is incorporated herein by reference.

### FIELD

The present disclosure relates generally to food waste disposers, and more particularly, to stamped swivel lugs on a rotating shredder plate.

### BACKGROUND

This section provides background information related to the present disclosure, which is not necessarily prior art.

A food waste disposer of the type that is disposed underneath a sink and is mounted to a drain opening of the sink typically includes a food conveying section, a motor section and a grind section. The grind section is disposed between the food conveying section and the motor section. The food conveying section conveys food waste and water to the grind section. The grind section receives and grinds the food waste and the ground food waste is discharged through a discharge opening to a tailpipe.

The grind section typically includes a grind mechanism with a rotating shredder plate assembly and a stationary grind ring. The shredder plate assembly is connected to a shaft of an electric motor of the motor section and includes a shredder plate with one or more lugs, typically one or more pairs of lugs. The lugs may include fixed lugs that are fixed to the shredder plate, rotatable lugs (also called swivel lugs) that are rotatably fastened to the shredder plate and are free to rotate thereon, or both. The shredder plate is rotated relative to the grind ring via the electric motor. The grind ring is typically mounted in a housing and includes multiple spaced teeth.

During operation of the food waste disposer, the food waste that is directed from the food conveying section to the grind section is forced by the lugs against the grind ring to comminute the food waste. When the lugs are swivel lugs, rotation of the shredder plate creates a centrifugal force that acts upon the lugs and enhances comminution of the food waste between the lugs and the grind ring. The sharp edges of the teeth grind the food waste into particulate matter (or ground matter). When the food waste is sufficiently ground, the food waste passes through gaps between the shredder plate and the grind ring and enters a discharge area in an upper end bell as a food waste/water slurry. It is then discharged out a discharge outlet in the upper end bell through a tail pipe to a drain line of household plumbing.

Food waste disposers can use either or both fixed and swivel lugs, as mentioned above. The advantage of fixed lugs is that they maintain a consistent gap and interface with the stationary grind ring, providing for finer grind and better comminution of food waste. The primary disadvantage is that food waste disposers with fixed lugs are more prone to jamming hard food waste, such as bones, between a face of one or more of the lugs and the stationary grind ring. Consequently, such food waste disposes typically have some type of anti-jam feature to overcome these jams, such as an anti-jam control circuit.

Swivel lugs or moveable lugs are typically fastened to the shredder plate of the rotating shredder plate assembly by a fastener and have rotational and/or radial range of motion about the fastener. The advantage of swivel lugs is that they are less likely to jam hard food waste between the lug face and the grind ring. The impact of hard food waste with the lug will cause the lug to rotate or travel away from the stationary grind ring, increasing the gap between the end face of the lug and the stationary grind ring.

A problem that sometimes occurs with a swivel lug is that food waste can become lodged under the lug and prevents the lug from rotating freely. This condition may lead to diminished performance, that is, poorer comminution of the food waste, and may result in additional vibration and noise due to the rotational imbalance caused by the inability of the swivel lug to rotate freely.

Swivel lugs are typically powder metal lugs or stamped metal (usually steel) lugs. One of the advantages of a powder metal swivel lug is that adjacent faces can be at right angles to each other and create sharp edges. This is made possible due to the powder metal manufacturing process. The sharp edge at the bottom of the leading edge of the swivel lug is less likely to entice food waste under the lug and limits the size of food waste particles that can fit underneath the swivel lug. A primary disadvantage of powder metal swivel lugs is that they cost more relative to stamped metal lugs.

One disadvantage of the shape of existing swivel lugs that are stamped metal swivel lugs is that food waste can be channeled underneath the lug. As can be seen in FIG. 6, this is due to the fact that a leading face 600 of a typical prior art stamped metal swivel lug 602 has a rounded lower leading edge 604.

As used herein, the grind face of the swivel lug is the surface of the lug on the leading side that impacts the food waste pushing it into the stationary grind ring.

When the shredder plate is rotating at the rotational speed of the motor, the centrifugal force acting on the swivel lug will cause the center of gravity of the lug to locate on a radial line connecting the center of the plate and pivot joint. This is the neutral position for the lug during operation. During grinding the food waste pushes the lug into a lagging position relative to the direction of rotation. A problem that can occur with a swivel lug with a sharp corner at the leading vertical outer edge of the face of the swivel lug is that food waste can be caught between the sharp corner and the stationary grind ring causing a jam.

### SUMMARY

A food waste disposer includes a food conveying section, a motor section and a grind and discharge section. The grind and discharge section is disposed between the food conveying section and the motor section and includes a grind section and a discharge section. The food conveying section conveys food waste to the grind section. The grind section includes a grind mechanism having a stationary grind ring and a rotatable shredder plate assembly that rotates within the stationary grind ring to grind food waste. The rotatable shredder plate assembly is rotated by a motor of the motor section. The rotatable shredder plate assembly includes a rotatable shredder plate having a plurality of stamped metal swivel lugs fastened thereon. Each lug includes a base and a face member at a radially outer end extending vertically upward from the base. The face member includes a grind face that bends radially inwardly with a rounded leading vertical outer edge. The base of each lug has a leading edge with a sharp lower edge.

In accordance with an aspect, a trailing edge of an outer wall of the face member of each lug has an angled upper edge.

In accordance with an aspect, wherein each lug has a boss formed therein at a radially outer end where the grind face member extends upwardly from the base.

### BRIEF DESCRIPTION OF THE DRAWINGS

Other objects and advantages of the invention will become apparent upon reading the following detailed description and upon reference to the drawings in which:

FIG. 1 is a sectional view of a food waste disposer in accordance with an aspect of the present disclosure;

FIG. 2 is a perspective view of a rotating shredder plate assembly for the food waste disposer of FIG. 1 having stamped metal swivel lugs in accordance with an aspect of the present disclosure;

FIG. 3 is a side perspective view of one of the stamped metal swivel lugs of FIG. 2;

FIG. 4 is a top plan view showing the rotating shredder plate assembly of FIG. 2 in the food waste disposer of FIG. 1 with the stamped metal swivel lugs in a neutral position;

FIG. 5 is a top plan view showing the rotating shredder plate assembly of FIG. 2 in the food waste disposer of FIG. 1 with the stamped metal swivel lugs in a lagging position; and

FIG. 6 is a side perspective view of a prior art stamped metal swivel lug.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention.

### DETAILED DESCRIPTION

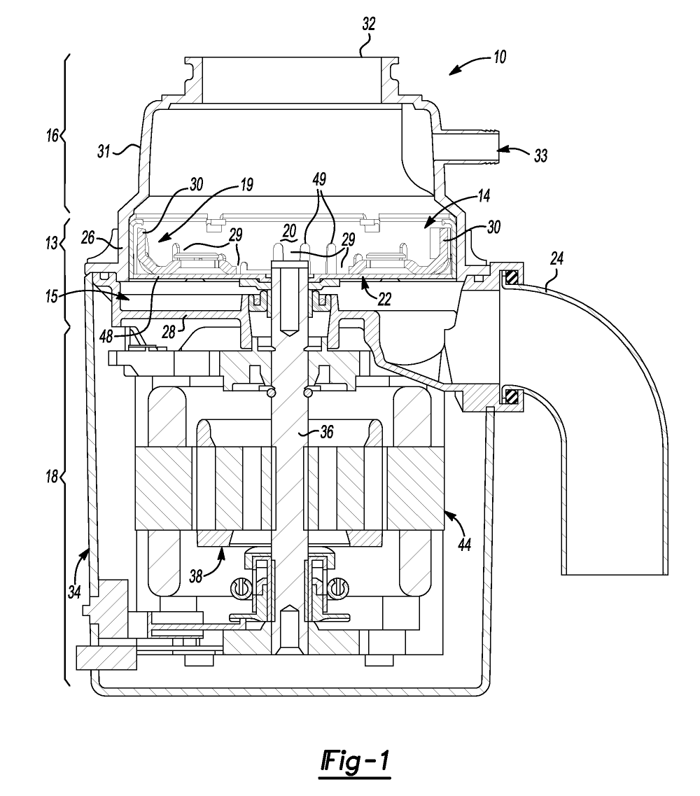

In FIG. 1, a food waste disposer 10 is shown. The food waste disposer 10 includes a grind and discharge section 13 disposed between a food conveying section 16 and a motor section 18. The grind and discharge section 13 includes a grind section 14 and a discharge section 15. The grind section 14 includes a grind mechanism 19 with a stationary grind ring 20 and a rotatable shredder plate assembly 22. The rotatable shredder plate assembly 22 includes a rotatable shredder plate 48 on which stamped metal swivel lugs 30 are rotatably fastened. Stamped metal swivel lugs 30 are formed by stamping them such as from sheet metal.

The grind section 14 includes a grind housing 26 that encompasses the grind mechanism 19. The grind housing 26 may be fastened to an upper end bell (UEB) 28 of the discharge section 15 and holds the stationary grind ring 20. The stationary grind ring 20 is mounted in a fixed (stationary) position within the grind housing 26. The stationary grind ring 20 includes teeth 29. The stationary grind ring 20 may be fixedly affixed to an inner surface of the grind housing 26 by an interference fit and may be composed, for example, of galvanized steel.

The food conveying section 16 includes an inlet housing 31 with a first inlet 32. The first inlet 32 receives food waste and water. The inlet housing 31 may be a metal housing or an injection molded plastic housing. The inlet housing 31 also includes a second inlet 33 for receiving water discharged from a dishwasher (not shown). The inlet housing 31 may be integrally formed with the grind housing 26, such as by injection-molding both of the housings 26, 31 as a single component.

The motor section 18 includes a motor 34 having a rotor 38 and a stator 44. Rotor 38 rotates in stator 44 imparting rotational movement to a rotor shaft 36 of a rotor 38. Motor 34 may be an induction motor, but may be other types of motors. The rotor shaft 36 is connected to and rotates the rotatable shredder plate assembly 22 within the stationary grind ring 20.

During operation of the food waste disposer 10, the rotatable shredder plate assembly 22 is rotated by motor 34. Due to the rotation of the rotating shredder plate assembly 22, lugs 30 force the food waste against the teeth 29 of grind ring 20 to grind the food waste into small particulate matter. A slurry of the particulate matter and water passes from the rotatable shredder plate assembly 22, outside a periphery of rotatable shredder plate 48, through gaps 49 between the teeth 29 to a discharge area below the shredder plate assembly 22 and in the UEB 28. It is then discharged out a discharge outlet of UEB 28 through tailpipe 24 to a drain line (not shown).

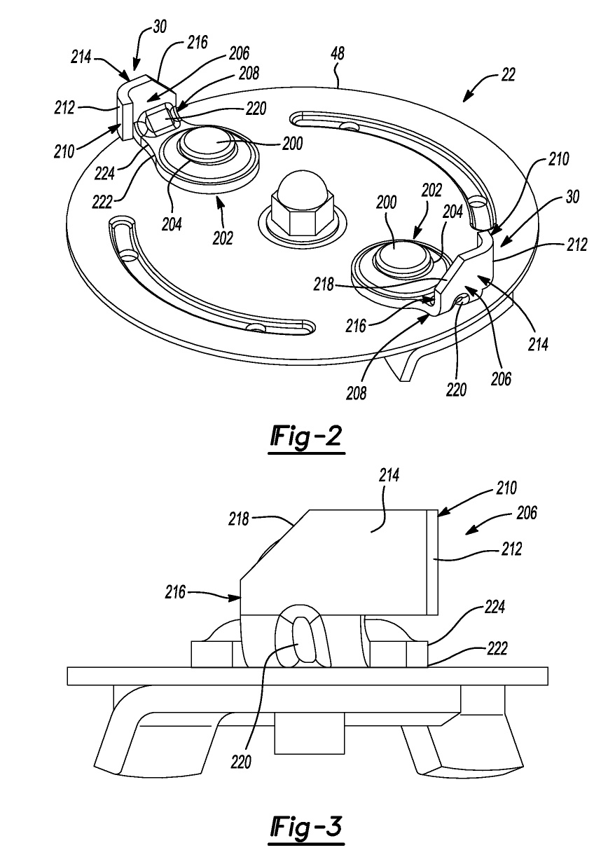

FIG. 2 is a perspective view of rotatable shredder plate assembly 22 showing in more detail stamped metal swivel lugs 30 rotatably fastened on rotatable shredder plate 48 by fasteners 200. As oriented in FIG. 2, rotatable shredder plate assembly 22 rotates counterclockwise. Fasteners 200 may for example be rivets, but it should be understood that fasteners 200 could be other types of fasteners. As used herein, a stamped metal swivel lug means a swivel lug that is formed by stamping it from metal, such as sheet steel.

With reference to FIGS. 2 and 3, each stamped metal swivel lug 30 has a base 202 having a hole 204 through which fastener 200 is received and a face member 206 at a radially outer end 208 extending vertically upward from base 202 (as oriented in the drawings and as oriented when food waste disposer 10 is mounted to a sink). Face member 206 includes a grind face 210 that bends radially inwardly. Grind face 210 has a rounded leading vertical outer edge 212. Face member 206 also includes outer wall 214 that faces stationary grind ring 20 (FIG. 1). Rounded leading vertical outer edge 212 has a radius that is larger compared to the leading vertical outer edge of typical powder metal swivel lugs.

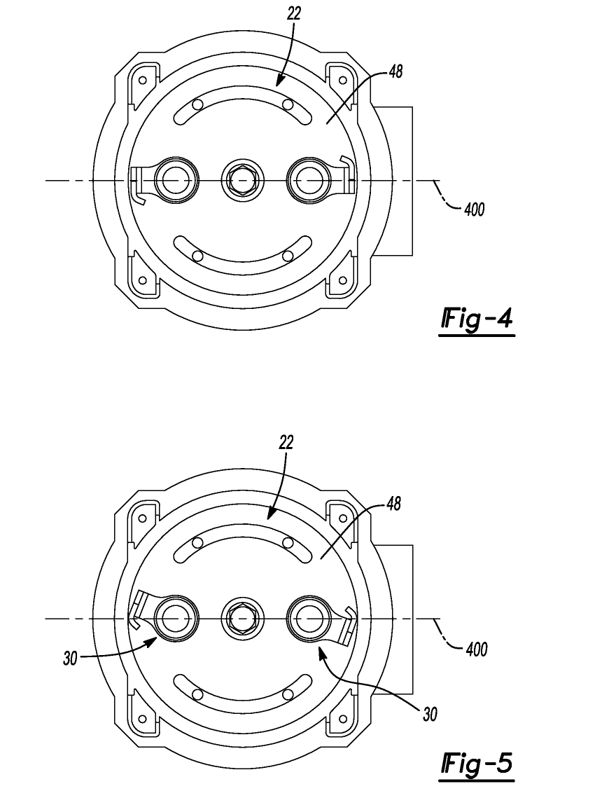

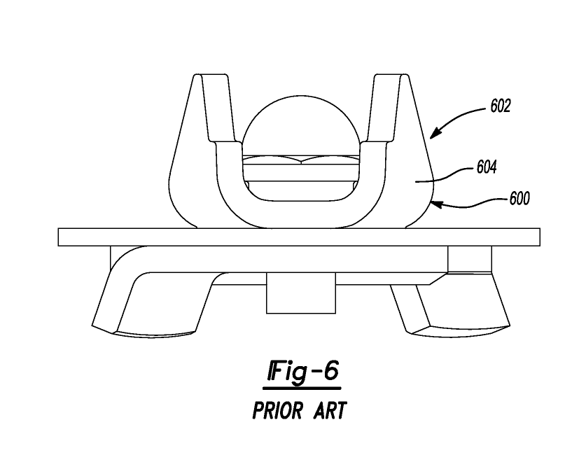

When the food waste disposer 10 is operating, the shredder plate assembly 22 is rotating at the rotation speed of motor 34. Centrifugal force acting on the stamped metal swivel lugs 30 cause the center of gravity of each stamped metal swivel lug to locate on a radial line 400 (FIGS. 4 and 5) connecting a center of rotatable shredder plate 48 and a pivot point of the stamped metal swivel lug, typically at a center of fastener 200. This is the neutral position of the stamped metal swivel lugs 30 as shown in FIG. 4. When food waste is being ground, the grinding of the food waste pushes the stamped metal swivel lugs 30 into a lagging position relative to the direction of rotation of rotatable shredder plate assembly 22, as shown in FIG. 5. During grinding of food waste when stamped metal swivel lugs 30 are in the lagging position, the larger radius of rounded leading vertical outer edge 212 of grind face 210 of stamped metal swivel lug 30 offers less of an opportunity for food waste to jam between rounded leading vertical outer edge 212 and stationary grind ring 20 compared to the smaller radius of the leading vertical edge of a typical powder metal swivel lug.

A trailing edge 216 of outer wall 214 of face member 206 may have an angled upper edge 218. A boss 220 may be formed in stamped metal swivel lug 30 at radially outer end 208 where face member 206 extends upwardly from base 202.

A lower edge 222 of a leading face 224 of base 202 is sharp. That is, in accordance with an aspect, stamped metal swivel lug 30 is formed so that leading face 224 of base 202 is at a right angle to a bottom face of base 202. The sharp lower edge 222 of leading face 224 of stamped metal swivel lug 30 makes it less likely that food waste will be able to enter under stamped metal swivel lug 30 and become lodged preventing stamped metal swivel lug from rotating freely. Stamped metal swivel lug 30 is thus formed by stamping having sharp lower edge 222 comparable to the sharp lower edge that prior art powder metal swivel lugs have, as discussed in the background of the present application. It should be understood that lower edge 222 can be sharp with leading face 224 other than at a right angle to bottom face of base 202.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified and all such variations are considered within the scope and spirit of the invention.

What is claimed is:

1. A food waste disposer, comprising:
a food conveying section, a motor section and a grind and discharge section disposed between the food conveying section and the motor section, the grind and discharge section includes a grind section and a discharge section;
the grind section includes a grind mechanism having a stationary grind ring and a rotatable shredder plate assembly that rotates within the stationary grind ring to grind food waste, the rotatable shredder plate assembly rotated by a motor of the motor section;
the rotatable shredder plate assembly includes a rotatable shredder plate having a plurality of stamped metal swivel lugs rotatably fastened thereon; and
each lug including a base and a face member at a radially outer end extending vertically upward from the base, the face member including a grind face that bends radially inwardly with a rounded leading vertical outer edge, the base of each lug having a leading face with a sharp lower edge.

2. The food waste disposer of claim 1 wherein a trailing edge of an outer wall of the face member of each lug has an angled upper edge.

3. The food waste disposer of claim 2 wherein each lug has a boss formed therein at a radially outer end where the face member extends upwardly from the base.
